(19) United States
(12) Patent Application Publication
(10) Pub. No.: US 2011/0225133 A1
(43) Pub. Date: Sep. 15, 2011

(54) METADATA-AWARE SEARCH ENGINE

(75) Inventors: Mitica Manu, Sammamish, WA (US); Jack Pullikottil, Bothell, WA (US)

(73) Assignee: Microsoft Corporation, Redmond, WA (US)

(21) Appl. No.: 12/720,205

(22) Filed: Mar. 9, 2010

(51) Int. Cl. G06F 17/30

(52) U.S. Cl. 707/706; 707/769; 707/723; 707/E17.108; 707/E17.014

(57) ABSTRACT

Described herein are various principles that may be used together or separately to implement a search engine to retrieve and use metadata information in performing a search. In one embodiment described herein, a search engine accepts input from a user that describes a search the user desires to be performed. The search engine may then examine the input to determine whether the input relates to an artifact and to what artifact the input relates. The search engine may then retrieve metadata information from a source related to the determined artifact and use the metadata information in performing the search requested by the user.

### BACKGROUND

A search engine is a software program that searches a set of content for a particular content unit or particular content units. Search engines can be implemented in various ways to search in different contexts and for different content. An enterprise search engine can be used to search for content such as documents, files, and e-mail messages, in an enterprise network. A web search engine can be used to search for World Wide Web content, including web pages. Other types of search engines can be used in other contexts.

Search engines perform a search based on input provided by a user of the search engine. The search engine will accept the input provided by the user and examine a set of content for content units that match the input. For example, a user may provide one or more text keywords as input and the search engine may examine the set of content to find documents containing those text keywords.

After examining the set of content, the search engine will have located a list of content units (unless the search was unsuccessful and did not match anything in the set of data). The list of content units is the result of the search performed by the search engine. This list may be presented to the user in some order, including according to a ranking. For example, content units in the list may be ranked according to a number of occurrences of the text keywords in each document or a number of references that were made to each document by other documents (which may indicate an importance of a content unit).

Typically, search engines perform searches as outlined above, searching based only on the input provided by each user. Some search engines, though, may make inferences about the input and may augment or supplement the input based on those inferences. For example, if for many searches performed by a search engine, in the input describing the search the term “Boston” is followed by the terms “Red Sox,” then the search engine may infer that these two terms are related. Once this inference is made, if the search engine receives later input regarding a search to be performed that contains “Boston,” but not “Red Sox,” the search engine may add “Red Sox” to the input and perform a search based on both terms. Alternatively, if the search engine receives input containing “Boston,” but not “Red Sox,” the search engine may perform the search using the term “Boston,” but may rank content units that include both the terms “Boston” and “Red Sox” higher than content units that only include “Boston.” The search engine may do this because the search has determined that there is probably a link between the two terms and a user that is looking for information regarding one of the terms may be looking for information regarding the other term.

Search engines may also make inferences about information contained in content units found during a search. For example, if the term “Red Sox” is found in many of the content units that were found based on the search “Boston,” then the search engine may infer that these two terms are related. The search engine may then add the term “Red Sox” to searches or rank results that include the term “Red Sox” higher, as outlined above.

### SUMMARY

Conventional search engines are constrained to performing searches based on the information available to the search engines. For conventional search engines, this information is in the form of input from the user or inferences made based on the input or the set of content to be searched.

Thus, when a search engine performs a search relating to an artifact, that search engine can perform the search and rank results based on the input from the user and the inferences made.

An artifact may be associated with one or more pieces of metadata that may be related to the artifact. The pieces of metadata may provide some information about the artifact that may be relevant to a search of an artifact. For example, the metadata may indicate attributes of an artifact, such as a creator of an artifact, a time the artifact was created, a type of the artifact, or other attributes. These pieces of metadata may not be in the set of content to be searched or in the input from the user. Rather, these pieces of metadata may be stored elsewhere, such as in a private storage of a creator of the artifact. Accordingly, a conventional search engine does not have access to this metadata.

A search engine may be improved, and results provided by the search engine may be improved, if the search engine could access metadata and use the metadata in a search. Described herein are various principles that may be used together or separately for operating a search engine to retrieve and use metadata information in performing a search.

In one embodiment of some of these principles that is described below, a search engine may accept input from a user that describes a search the user desires to be performed. The search engine may then examine the input to determine whether the input relates to an artifact and to what artifact the input relates. The search engine may then retrieve metadata information from a source of metadata related to the determined artifact and use the metadata information in performing the search requested by the user.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flowchart of one process that may be implemented in a search engine for performing a search based on user input and on metadata related to an artifact to which the input relates;

FIG. 2 is an illustration of one exemplary computer system in which the process illustrated in FIG. 1 may be implemented;

FIG. 3 is a flowchart of one process that may be implemented to receive input regarding a search to be performed;

FIG. 4 is a flowchart of one process that may be implemented in a search engine to identify an artifact to which input relates;

FIG. 5 is a flowchart of one process that may be implemented in a search engine to identify an artifact to which input relates based on text keywords of the input and text keywords related to artifact(s);

FIG. 6 is a flowchart of one process that may be implemented by a search engine to retrieve information about one or more artifacts;

FIGS. 7A and 7B are flowcharts of exemplary processes for using an Application Programming Interface (API) to gather metadata about one or more artifacts;

FIGS. 8A and 8B are flowcharts of exemplary processes that may be implemented by a search engine to use metadata information to perform a search;

FIG. 9 is a flowchart of one process that may be implemented by a search engine to provide results of a search to a user;

FIG. 10 is a flowchart of another exemplary process that may be implemented by a search engine to retrieve metadata information related to a search;

FIG. 11 is a flowchart of an exemplary process that may be implemented by a search engine to maintain a local source of metadata information for use in retrieving metadata related to searches;

FIG. 12 is a flowchart of an exemplary process that may be implemented by a search engine to retrieve additional metadata to use in performing a search; and

FIG. 13 is a block diagram of exemplary computing devices with which some embodiments may be implemented.

### DETAILED DESCRIPTION

A search engine can be improved and can provide better results if more reliable or relevant content units are provided as results of a search and content units that are less reliable and less relevant are not provided or are indicated in some way as less reliable or less relevant (e.g., through a ranking).

Conventional search engines are adapted to search a set of content based on input provided by a user and/or content units that are in the set. Search engines may make inferences and determine relationships based on the input or the set of data that attempt to improve results of a search and find more reliable or relevant content units. Conventional techniques are constrained, though, to making inferences based on that information available from the user input or available from the set of data. Accordingly, conventional search engines are limited to searching and providing results based on user input, the set of content to be searched, and information that can be determined from a probabilistic inference.

Information available outside of the input from the user or the set of content to be searched may be useful to a search engine in locating reliable or relevant content units. For example, metadata may exist and be stored in private networks about artifacts that describes the artifacts. Metadata may describe an artifact, or may describe one or more attributes of an artifact, and may be useful to a search engine in performing a search related to an artifact. This metadata, though, may not be available via the input from the user or in the set of content to be searched. Rather, this metadata may be stored elsewhere, inaccessible to conventional search engines.

If a search engine is able to determine an artifact that is related to a search or is a subject of a search, determine that metadata exists for the artifact, and retrieve the metadata about the artifact, the metadata may be useful to the search engine in performing the search. For example, the metadata may be used in locating reliable and relevant content units and/or in presenting those reliable and/or relevant content units as results of the search.

Accordingly, described herein are principles for operating a search engine to retrieve metadata regarding artifacts and to use the metadata in performing a search relating to an artifact. The principles described herein may be used together or separately, or in any combination, to operate a search engine that uses metadata to perform a search.

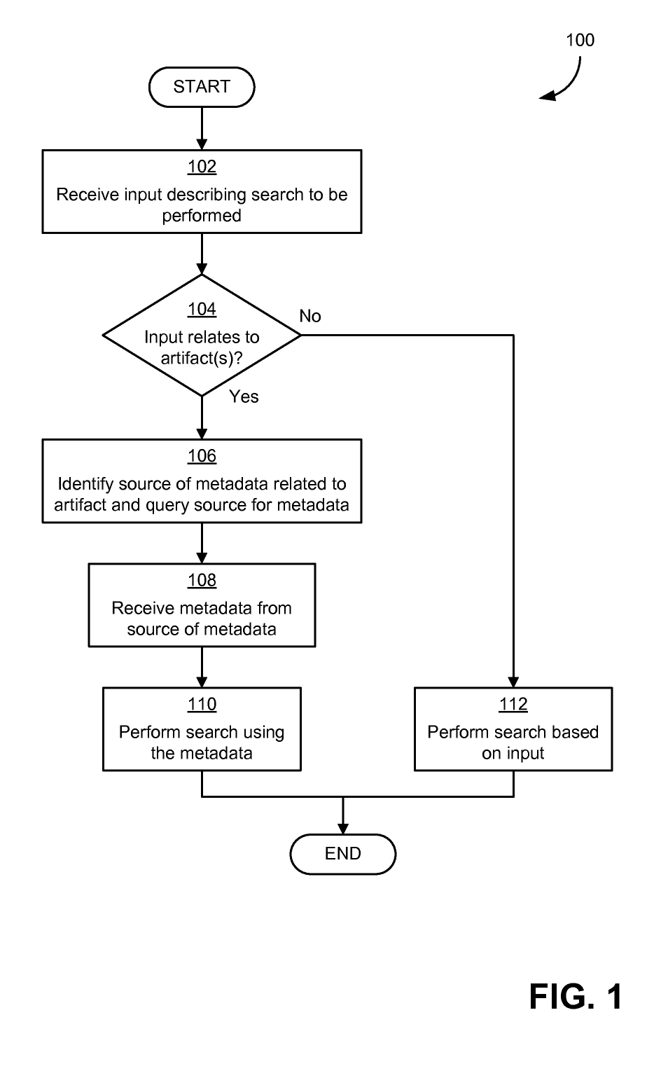

FIG. 1 shows one illustrative technique for operating a search engine to retrieve metadata regarding an artifact and use the metadata in performing a search regarding the artifact. FIG. 1 is provided as an illustration of an overall process that may be followed by some search engines that operate according to some of the principles described herein. Some of the individual acts discussed in connection with the process of FIG. 1 are described in detail below, as well as exemplary techniques that may be used in some embodiments for carrying out these acts.

The process 100 of FIG. 1 begins in block 102, in which an entity requests that a search be performed by providing input to a search engine describing a search the entity desires to be performed. The nature of the entity and the nature of the input is not essential. In embodiments, an entity may be any requestor of a search, including users such as human users and software agents, and the input may be any suitable input to a search engine, including text (e.g., keywords) or binary data (e.g., an image file). For ease of description, in examples below an entity may be described as a user or human user and the input may be described as text keywords, though embodiments are not limited in this respect.

In block 104, after receiving the input, the search engine (or a software component of the search engine or related to and communicating with the search engine) examines the input to determine whether the input relates to one or more artifacts. An artifact, as used herein, may be any subject of a search and any subject about which information can be generated and about which information may be available. Artifacts include physical objects (e.g., software products, still images, videos, food, buildings, cities, etc.), entities (e.g., commercial enterprises, people, etc.), content units, topics or categories of information, pieces of information, and ideas, among others.

A user may desire information concerning an artifact and may desire the search engine to perform a search relating to the artifact to find that information. For example, the user may desire instructions on using a particular feature of a software application. The user may, therefore, provide input to the search engine relating to that artifact. To determine whether the search relates to an artifact, the search engine may examine the input provided by the user. A search engine may use any suitable technique to determine whether the input relates to an artifact, including any exemplary techniques discussed below.

In some techniques, a listing of artifacts may be stored by the search engine or stored in a location accessible to the search engine, and each of the artifacts in the listing may be associated with one or more pieces of information. This listing may be created and/or maintained in any suitable manner, including by an administrator or through an automated process, as embodiments are not limited in this respect. In such embodiments, determining whether input relates to an artifact may include comparing the input to the pieces of information associated with one or more artifacts.

For example, in one embodiment, text keywords are accepted as input and text keywords are associated with each artifact. The search engine may then compare the text keywords of the input to the text keywords associated with one or more artifacts. If any of the text keywords of the input match the text keywords of an artifact, then the input may be determined to match the artifact. For example, an artifact may be the Microsoft® Word word processing application available from the Microsoft Corporation of Redmond, Wash. The artifact may be associated in records of the search engine with the text keywords “microsoft word” and/or any keywords associated with particular features of Microsoft® Word. If a user provides input that includes the keywords “microsoft word,” then at least some the text keywords of the input will match at least some of the text keywords of the artifact. This match of keywords may indicate that the input is related to the artifact and that the user desires information regarding the artifact. As discussed above, if the search engine determines that the search desired by the user relates to an artifact, then metadata may be retrieved that relates to the artifact and that may aid the search engine in determining content units that are relevant and/or reliable to present as results of a search.

If the input is determined in block 104 not to relate to an artifact, then the process 100 continues to block 112 to perform the search based on the input. The search may be performed in block 112 in any suitable manner, including according to known search engine techniques. The manner of performing a search without using metadata is not essential.

However, if the input is determined in block 104 to match an artifact, then in block 106 a source of metadata for that artifact is identified. As discussed above, an artifact may be associated with one or more pieces of metadata. Metadata may be any information that describes an artifact. Metadata may include information about one or more attributes of the artifact. For example, the metadata may identify a person or group who created the artifact, such as an author of a document, a developer of a software program, or a director of a video/film. Metadata may identify equipment used to create an artifact, such as a development environment for a software program or a camera used to create a still image. Metadata may also describe a size of an artifact, including a physical size or a data storage size. Metadata may describe a past, present, or future location of an artifact. Any suitable information that describes an artifact may be metadata.

Metadata may have been created at any suitable time and in any suitable manner, as embodiments are not limited in this respect. For example, metadata may have been created when an artifact was being processed or considered, including when the artifact was being created, tested, reviewed, stored, or processed at any other time and in any other way. Once the metadata has been created, the metadata may be stored at and retrieved from any suitable location, including the location at which the metadata was created and/or at some other location. In some embodiments, metadata may be stored at and retrieved from a location that aggregates metadata that was created at one or more other locations. A location creating and/or storing metadata may act as a source of metadata. A search engine may retrieve metadata from any suitable source of metadata.

Each artifact may be associated with at least one source of metadata, and information may be stored that associates the artifact with the source(s) of metadata. The information that associates the artifact with the source(s) of metadata may identify an ontology for each source of metadata, describing a type of metadata stored by each source of metadata and one or more artifacts to which the metadata for each source relates. Accordingly, when a search engine matches input to an artifact, the search engine may use the information associated with the artifact to determine a source of metadata relating to the artifact.

In block 106, the source of metadata may be queried for metadata relating to the artifact. This query may be done in any suitable manner, including according to any of the exemplary techniques described in greater detail below. In one exemplary technique, the artifact may be identified in a query sent to the source of metadata. For example, at least a portion of the input may be included in a query sent to the source of metadata. In block 108, metadata is received from the source of metadata in response to the query of block 106.

In block 110, the metadata received in block 108 is used to perform the search requested in block 102. Metadata may be used to aid the search engine in determining relevant and/or reliable content units to present as results of a search, such that the search engine provides results that some users may consider better.

Some examples of ways in which metadata may be used to perform a search are discussed in greater detail below. One way that metadata may be used in some embodiments to perform a search is in ranking results. For example, input describing a search to be performed may include text keywords, a set of content to be searched by a search engine may include text documents, and metadata that is received may include additional text keywords. A search engine may search the set of content and determine a set of documents that include the text keywords of the input. The search engine may then use the additional text keywords of the metadata to rank the documents in the results, such that documents that include the metadata keywords are ranked higher than documents that do not. It should be appreciated, though, that this is only one example of a way in which metadata may be used in performing a search. Metadata may be used in any suitable manner by search engines, and the manner in which metadata is used may vary depending on a type of search engine, a type or format of content being searched by a search engine, a type or format of information contained in the metadata, and other factors.

It should also be appreciated that, as used herein, “performing a search” includes all actions relating to a search. In some search engines, performing a search may include configuring the search engine to perform a search, searching (i.e., examining a set of content based on search parameters), processing results of the searching (e.g., ranking, filtering, etc.), and/or presenting processed results of the searching as the results of the search. Metadata may be used in any way to perform a search and therefore can be used in any one or more of the actions included in performing a search.

After a search is performed in either block 110 or block 112, then the process 100 ends. In some cases, the results of a search may then be displayed to a requestor of a search in any suitable manner. In some cases, displaying results of a search to a user may include displaying to the user an identification of the artifact(s) to which the input was determined to relate and/or an identification of information provided to the source(s) of metadata. Sources of metadata that were contacted may also be identified, in some embodiments. Any suitable information about the source(s) of metadata and the artifact(s) may be communicated to a user along with results of a search. It should be appreciated, though, that the results may be used in any way and embodiments are not limited to displaying the results of a search to a user. The manner in which results of a search are used once the search has been performed is not essential.

For illustration, one particular implementation of the process of FIG. 1 is now described.

In one implementation of techniques described herein, a user may submit to a search engine input that describes a search the user would like performed regarding a software application. For example, the user may be working with the Microsoft® Word word processing software, available from the Microsoft Corporation of Redmond Wash., and may have a question about how to use the spell checker of the software application. The user may provide input including text keywords such as “checking spelling in microsoft word.” The search engine, operating according to some of the techniques described below, may examine the input to determine whether the input relates to an artifact. In this case, by examining the input from the user, the search engine may determine that the input relates to the Microsoft® Word software application and/or to the spell checker. The search engine may then determine a source of metadata regarding Microsoft® Word, which in this case may be a metadata server maintained by the Microsoft Corporation. The search engine may query the source of metadata for metadata regarding Microsoft® Word and/or the spell checker and may retrieve metadata from the source. The metadata received from the source, in this case, may be a name of a chief developer of that particular feature of Microsoft® Word. The search engine may then use the name of the chief developer in performing the search. For example, the search engine may search the web for web pages relating to spell checking in Microsoft® Word and, using the metadata, rank highly in the results an article that was written by the chief developer about the spell checker in Microsoft® Word. This may be done because the search engine, having the metadata that gives the name of the chief developer, is aware that the chief developer may be a good source of information about the particular feature. An article written by the chief developer may therefore be determined to be a reliable or relevant result of the search and be ranked highly in the results.

It should be appreciated that the specific implementation described above is provided only for illustration purposes and is not intended to characterize embodiments or limitations of embodiments in any way. Embodiments are not limited to performing any of the exemplary techniques described in the specific implementation and are not limited to operating with any of the exemplary types of information (e.g., exemplary artifacts and exemplary metadata) described in the implementation.

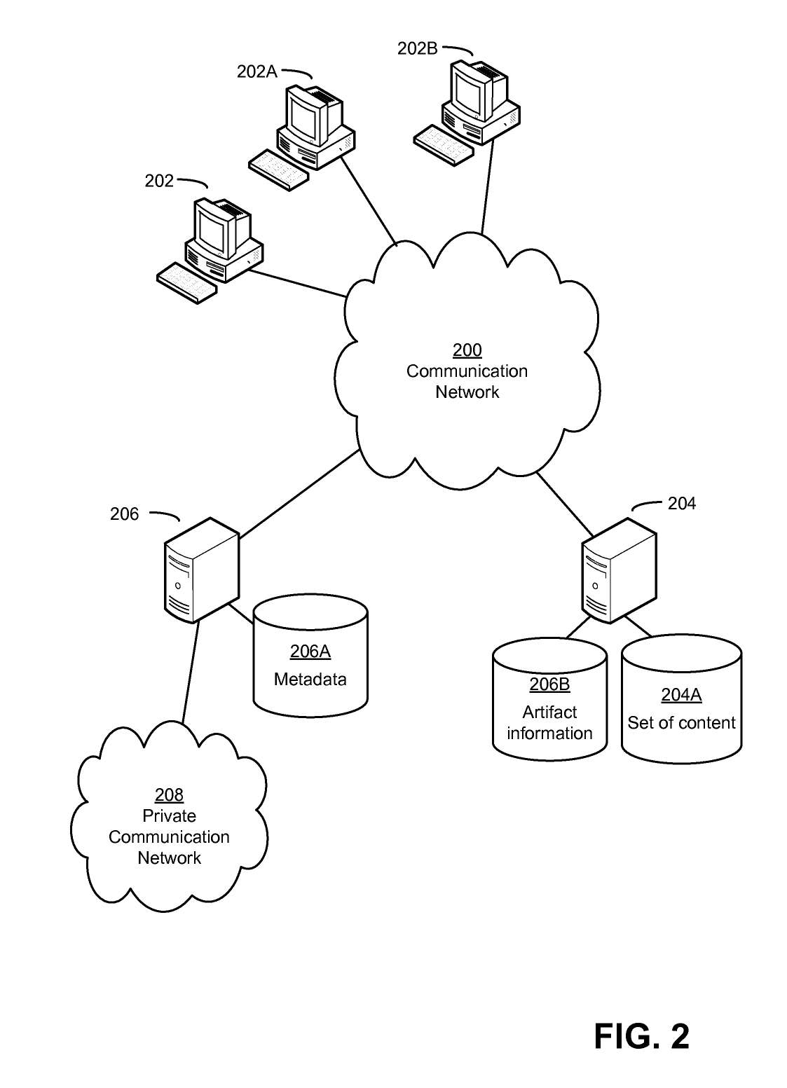

FIG. 2 shows one system in which a search engine operating according to the exemplary process illustrated in FIG. 1 may act. It should be appreciated, though, that the system of FIG. 2 is merely illustrative and embodiments are not limited to operating in any particular system or with any particular devices.

The system of FIG. 2 includes a communication network 200 to which a number of devices are connected. The communication network 200 may be any suitable communication network, including any suitable wired and/or wireless network. In some cases, the communication network 200 may be an enterprise network operated by a commercial enterprise and in other cases the communication network 200 may be the Internet or another public network.

The devices connected to the communication network include client devices 202, 202A, and 202B. Client device 202 (and devices 202A and 202B) may interact with a human user to receive input regarding a search the user desires to be performed and to present results of searches that have been performed. The client device 202 may interact with a user to receive or present information regarding a search through any suitable user interface. In some embodiments, the user interface may be a web page presented via a web browser.

Client device 202, upon receiving input from a user describing a search, may communicate at least a portion of that input to a server 204 that hosts and operates a search engine. While server 204 is illustrated as a single server, it should be appreciated that in some embodiments the server 204 may be implemented as a set of multiple servers sharing a processing burden and/or intercommunicating to host and operate a search engine.

The search engine hosted by the server 204 is adapted to perform a search based on input regarding a search. The search engine may therefore perform a search based on the input provided by the client device 202, which was provided to the client device 202 by the user. The search engine may, based on the input, perform a search of a set of content 204A. The set of content 204A may include one or more content units that are able to be searched by the search engine and that may be indicated as results of a search. The content units of the set of content 204A may be of any suitable type and any suitable format, including multiple types and formats. The type and format of the content units may vary depending on the type of search engine.

The set of content may be a set of information available to the search engine to be searched. In some cases, the set of content 204A may be a data set stored in a location accessible by the search engine that includes the information to be searched. For example, in the case of a web search engine, the set of content 204A may be a data store of web content that is accessible by the search engine, that was created by web crawlers retrieving and storing web content from other servers. Though the set of content 204A is illustrated in FIG. 2 as a single unit, accessible to the server 204 as a local data store or network-accessible data store, in some cases the set of content 204A may be stored in various locations and in various parts. The manner of storage or location of the set of content 204A is not essential.

As discussed above, in some embodiments a search engine may use metadata regarding an artifact to perform a search regarding the artifact. Accordingly, in some embodiments, a set of information regarding artifacts 204B may also be stored in a location accessible to the search engine. The set of artifact information 204B may include any suitable information regarding artifacts, including a listing of artifacts, a listing of sources of metadata for each artifact, and/or information about each artifact that may be used to determine whether a search requested to be performed relates to an artifact.

The artifacts in the listing may be any suitable artifacts, and the listing may be determined in any suitable manner. For example, an automated process may be used to generate a listing of artifacts and the set of artifact information 204B based on searches previously performed by the search engine and/or by analyzing content units of the set of content 204A and any other source of information. As another example, an administrator of the search engine may configure the listing of artifacts and the set of artifact information 204B based on information available to the administrator.

As another example, the search engine (or an operator or owner of the search engine) may establish relationships with one or more sources of metadata (or an operator or owner of a source of metadata). Each source of metadata may be operated as a repository of metadata and managed by an entity, including by a commercial entity, that may wish to provide metadata for use by a search engine either for free or for a fee. When the search engine establishes a relationship with a source of metadata, the source of metadata may provide a listing of one or more artifacts about which the source has metadata, as well as information about the artifacts, information about the source, or any other suitable information that may be used in the set of artifact information 204B.

As one example of such a relationship, a software vendor that creates and distributes software applications may have available metadata regarding the software applications created and distributed by the vendor. For example, the software vendor may have metadata including a development environment for the application, the identities of developers who worked on the application, a release schedule for versions of the application, a change history for the application, or any other information about a software application or about attributes of a software application that may be used as metadata.

The software applications of this example may be artifacts, and the metadata regarding the software applications may be metadata regarding artifacts. The software vendor may therefore act as a source of metadata and make this information available to a search engine. To do so, the software vendor may establish a relationship with the search engine such that the search engine is able to use the metadata to provide relevant and/or reliable results of a search. The software vendor may make this information available such that customers who are requesting searches regarding the applications are able to find relevant and/or reliable results and are able to find information about the applications and/or the software vendor may make the information available such that the software vendor can capitalize on this information. For example, the search engine and the software vendor may establish a relationship such that each time the software application retrieves metadata from the software vendor, the search engine pays the software vendor a fee.

Regardless of the content of the set of artifact information 204B or how the content is generated, the search engine, upon determining that input describing a search relates to an artifact and identifying a source of metadata for that artifact, may query the source of metadata 206 to retrieve the metadata. Querying the source of metadata may be done in any suitable manner. In some cases, the query may be transmitted over a secure connection between a search engine and a source of metadata. Establishing a secure connection between the search engine and the source of metadata may involve an authentication process, including an authentication of a relationship between the search engine and the source of metadata as set forth below. Over the secure connection, any suitable type of query may be made, including a query according to the File Transfer Protocol (FTP) or a query using an Application Programming Interface (API). A set of metadata 206A may be stored accessible to the source of metadata 206, such that the source of metadata may retrieve metadata in response to the query and provide the metadata to the search engine. While the set of metadata 206B is illustrated as a single unit, it should be appreciated that in some cases the set of metadata 206B may be stored as multiple units and/or in multiple locations. In some cases, the set of metadata 206B may be available from multiple locations in a network, such as communication network 200 or private communication network 208. In some implementations, the source of metadata 206 may aggregate metadata from multiple locations at the set of metadata 206B.

Once the source of metadata has provided the metadata to the search engine, the search engine will use the metadata to perform a search of the set of content 204A. Upon determining a set of results of the search, the results (or an indication of the results) will be transmitted to the client device 202 for presentation to the user.

It should be appreciated that while operations of a search engine and one system in which a search engine may operate were discussed generally in connection with FIGS. 1 and 2, the process and system illustrated in FIGS. 1 and 2 are merely illustrative. Embodiments are not limited to operating in the manner discussed in connection with FIG. 1 or in the system discussed in connection with FIG. 2. Further, while various examples were provided in the discussion above, it should be appreciated that each of these examples were merely provided to illustrate one way in which a particular component may operate, and that embodiments are not limited to operating in the manner described in connection with any of these examples.

Further, various additional examples are discussed below to better illustrate the operations of some embodiments. These examples are only given to provide an understanding of how these embodiments may operate. Other embodiments are not limited to operating in the manner discussed in these examples.

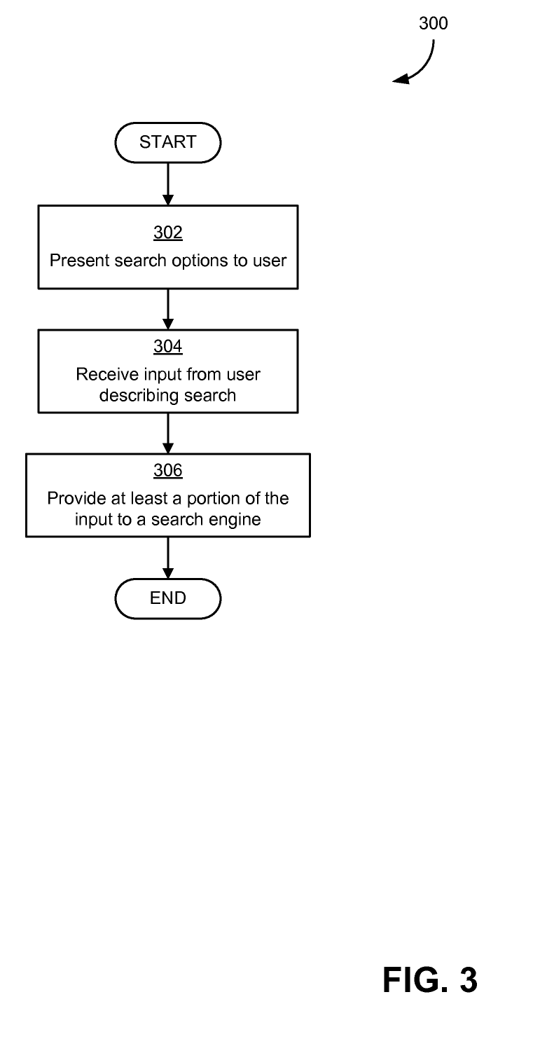

FIG. 3 shows an example of how one embodiment may operate to receive input regarding a search. It should be appreciated, though, that the content or format of input, or the manner of receiving input, is not essential.

In the process 300 of FIG. 3, input regarding a search to be performed is received from an entity requesting the search. In the example of FIG. 3, a human user is requesting the search.

The process 300 begins in block 302, in which search options are presented to a user. The search options can include any type of information that may be accepted as input from a user and any values that can be accepted for that type of information. The search options may be used to define attributes of content units that are to be returned as results of a search performed by the search engine, and so the search options may include attributes of content units. These attributes may vary based on the type(s) of content units to be searched. For example, search options may include a type or format of content units that should be searched, a creation time/date for content units, an application with which the content units were created or can be used, text keywords that the content units should include, binary data keywords (e.g., data that is a portion of or an entirety of an image) that the content units should include, or other options.

In block 304, input describing the search is received. The input may correspond to one or more of the search options presented in block 302. For example, the user may enter a date as a creation data for content units, or may provide text keywords that documents are to include. In examples given below, the input may be described as text keywords that documents are to include, but it should be appreciated that embodiments are not limited to receiving input that is or includes text keywords.

In block 306, at least a portion of the input that is received from the user is sent to a search engine. If the user provided the input directly to the same device that is hosting and operating a search engine, then the input may have been provided directly to the search engine or may be provided via a message-passing protocol internal to a computer. If the user provided the input to a device different from the device hosting and operating the search engine, then the input (or the portion of the input) may be transmitted to the device hosting the search engine across a communication network (e.g., communication network 200 of FIG. 2).

Once the input has been provided to the search engine, then the process 300 ends.

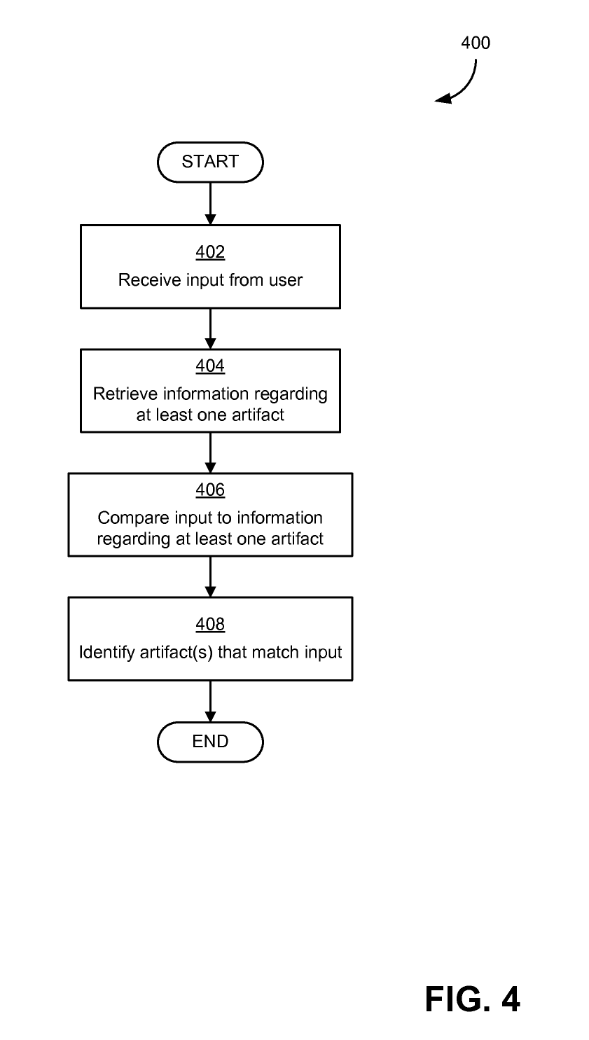

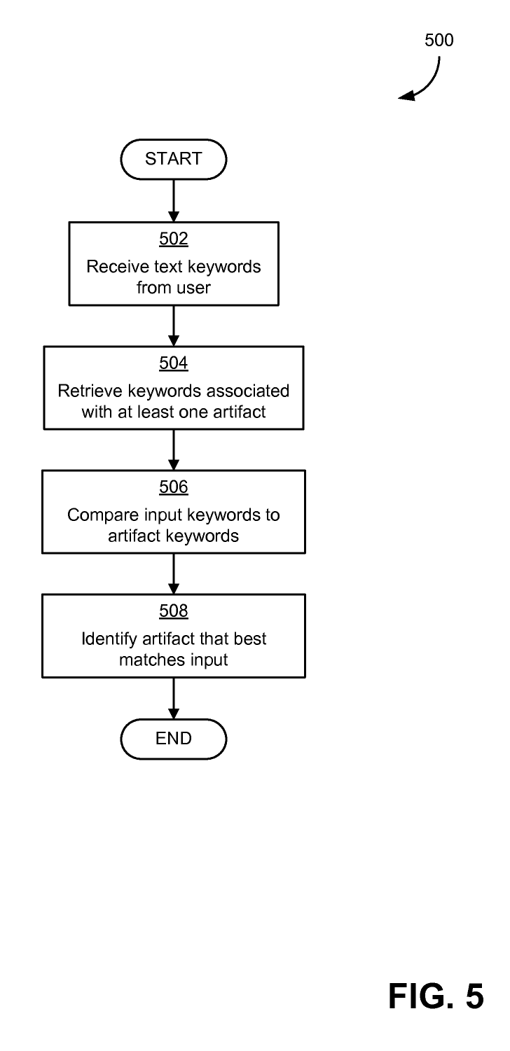

As discussed above, when a search engine receives input from a user (either directly, via transmission from another device, or in any other way), the search engine may determine whether the input relates to an artifact. FIGS. 4 and 5 illustrate exemplary processes that a search engine may follow to determine whether input relates to one or more artifacts.

The process 400 of FIG. 4 begins in block 402, in which input is received from a user. The input may include any suitable information, including any suitable information corresponding to search options.

In block 404, information regarding at least one artifact is retrieved. The information about the artifact may have been created in any suitable manner, as the technique(s) used to create information regarding an artifact that is stored by a search engine is not essential. As discussed above, the information may, in some embodiments, be created and maintained by an administrator, by an automated process, and/or in response to establishment of relationships with sources of metadata.

The information regarding the artifact(s) may include any suitable information about an artifact, and may vary based on the artifact. Information about the artifact could include one or more pieces of metadata that describe the artifact. For example, information regarding an artifact could include one or more names for an artifact, one or more text keywords associated with an artifact, and an identity of an owner or creator of an artifact. Any suitable information may be information regarding an artifact.

In block 406, the input is compared to the information regarding the artifact(s) to determine whether the input relates to one or more artifacts. The comparison technique used to determine a match between the input and one or more artifacts is not essential. Rather, the comparison may be done in any suitable manner and may depend on the type or format of the input and the type or format of the information regarding the artifact(s).

In embodiments, any correspondence between the input and the information regarding at least one artifact may be used to identify a match, such as a match between only one piece of information.

In some embodiments, the input regarding the search to be performed may be analyzed using natural language processing techniques. Natural language processing techniques are known in the art, and as such will not be discussed in detail herein. In some such embodiments, the natural language processing techniques may be used to identify a topic of a query to be used to identify an artifact, while in other such embodiments the natural language processing techniques may be used to identify an artifact.

In other embodiments, techniques may be used to identify an underlying question related to the input. Language mapping techniques, including iterative refinement techniques, may be used to identify a known question to which the input is related. Mapping techniques are known in the art, and as such will not be discussed in detail herein.

In embodiments that use natural language processing techniques or mapping techniques and that operate with input that includes text keywords, in some cases the text keywords may correspond to multiple different words or definitions. Some embodiments may, in such cases, use a most common definition or identify a most likely definition based on context. In other embodiments, multiple topics or artifacts may be identified based on the multiple words or definitions that are identified.

In some embodiments, a threshold level of correspondence will be used to determine whether a match exists, such as requiring three matches between pieces of information. Further, while in some embodiments all pieces of information may be weighted equally when determining a match, in other embodiments pieces of information may be weighted differently, such that if a name of an artifact appears in the input that may be weighted more heavily than if a creation date of an artifact appears in the input. Different weights may be used when different pieces of information may indicate more strongly than others a match.

Based on which technique is used to perform a comparison and determine a match, an output of block 406 may be different. For example, using some comparison techniques, a binary decision of “match” or “not match” may be produced as output, while in other techniques a match score may be output indicating how closely the input matches an artifact.

Regardless of how a comparison is performed and what result is output, the output of the comparison of block 406 between the input and the information regarding one or more artifacts is used in block 408 to identify the one or more artifacts to which the input relates. Block 408 may include collecting a listing of one or more matches generated in block 406 and evaluating the matches. The evaluating may include identifying a match between the input and one, two, or more artifacts, depending on the results of the comparison of block 406. In some cases where two or more artifacts are identified, each of the two or more artifacts may correspond to a possible topic of the input, based on multiple different possible interpretations of the input. In some such cases, identifying a match may include identifying a match between the input and the most likely artifact to which the input relates. The most likely artifact may be the strongest match based on the comparison, such as the artifact that has the most information matching the input, based on the comparison. In other cases, two or more artifacts may be identified where the input describing the search to be performed identifies two or more artifacts. For example, where a user is seeking information regarding a person who works at a business, an artifact corresponding to the person and an artifact corresponding to the business may be identified. In some such cases, both artifacts may be identified as artifacts to which the input relates, and sources of metadata associated with each of the artifacts may be used to retrieve metadata. Though, in some cases where two or more artifacts are identified, a user may be prompted to identify one of the artifacts to which the input relates. An artifact selected by the user may be treated as the artifact to which the input relates and a source of metadata associated with the selected artifact may be contacted.

Once the match is identified in block 408, the process 400 ends.

Process 500 of FIG. 5 is one illustrative implementation of the process 400 of FIG. 4, in which input from the user includes text keywords and the information about each artifact includes text keywords. Though, as discussed above, it should be appreciated that embodiments are not limited to operating with text keywords.

Process 500 begins in block 502, in which one or more text keywords are received as input from a user. The text keywords describe a search to be performed, in that the text keywords specify that documents that are to be located by the search engine should include one, some, or all of the text keywords.

In block 504, a set of text keywords relating to each artifact in a listing of artifacts is retrieved. The text keywords associated with each artifact may be any suitable words that may describe an artifact, including artifact names or one or more words that may be associated with the artifact. As each of the text keywords are associated with an artifact, a presence of one of the text keywords in the input may indicate that the input is related to the artifact.

In block 506, each of the text keywords of the input is compared to the text keywords associated with each of the artifacts to determine whether there is a match between any of the keywords. Each match is tracked, and a count for a number of matching keywords for each artifact is maintained. Once the input keywords have been compared to each of the text keywords for the artifacts, then the artifact with the most number of matching keywords is determined in block 508 to be the artifact to which the input relates. The process 500 then ends.

It should be appreciated that while each of the exemplary processes 400 and 500 of FIGS. 4 and 5 are described in terms of determining a match, in some cases an input may not relate to an artifact or the search engine may not be aware of the artifact to which the input relates. In these cases, an artifact to which the input relates will not be identified. If no artifact is identified, a search may be performed based on the input in any suitable manner, including according to conventional search techniques.

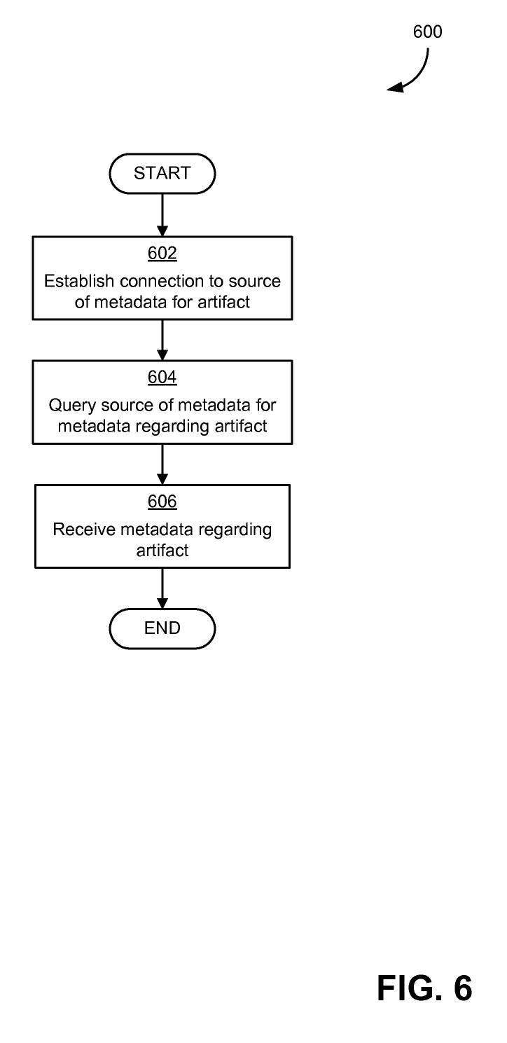

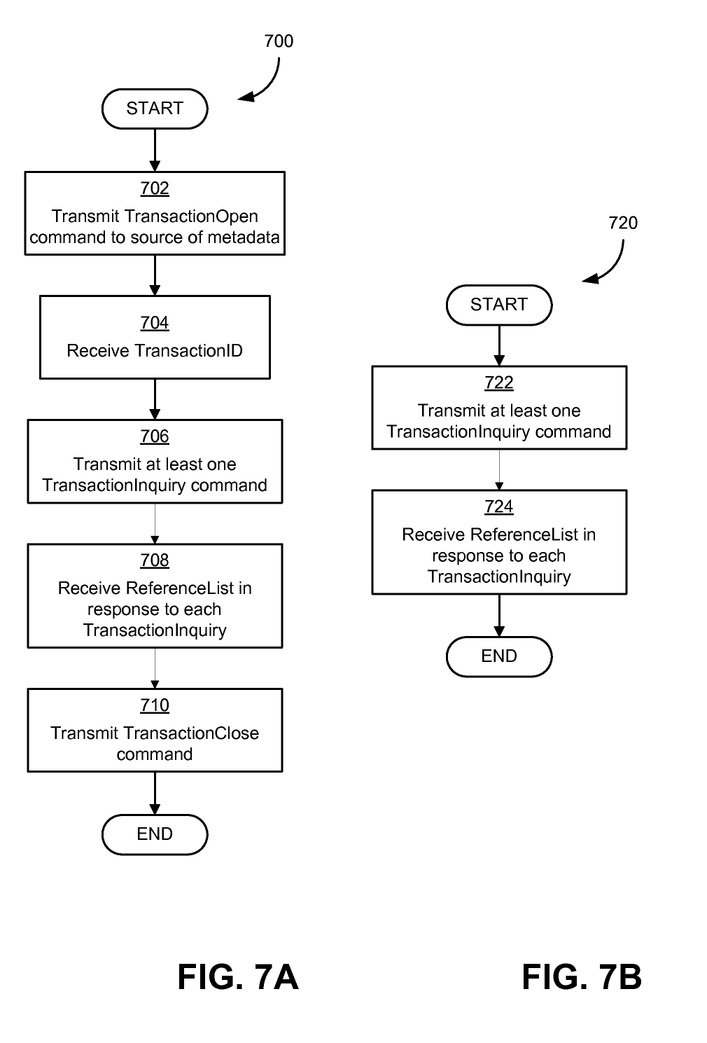

Once a match between the input and one or more artifacts is identified, then metadata regarding each artifact will be retrieved, such that the search engine can use the metadata in performing the search. FIGS. 6, 7A and 7B illustrate techniques for communicating between the search engine and one source of metadata to retrieve metadata regarding an artifact. If multiple artifacts are identified, then multiple queries may be sent to a source of metadata, or queries may be sent to each of multiple sources of metadata.

The process 600 of FIG. 6 begins in block 602, in which a connection is established between the search engine and the source of metadata. In block 604, a query is sent from the search engine to the source of metadata requesting metadata. The query may be formatted in any suitable manner and may include any suitable information, as the form of the query is not essential. In one exemplary implementation, the query may include only a request for metadata, with no information about the input or the artifact. This may be the case where, for example, a source of metadata includes metadata about only one artifact and will supply all metadata about the artifact in response to a query. In another implementation, all or a portion of the input may be provided in the query sent to the source of metadata. In another implementation, a name of an artifact or other information about an artifact may be provided in the query sent to the source of metadata. Any suitable information may be included in the query.

In block 606, a response to the query is received from the source of metadata that includes the metadata. Once the metadata is received in block 606, the process 600 ends.

FIGS. 7A and 7B show exemplary implementations of the process 600 using an Application Programming Interface (API). API calls may be made between programs and devices using any suitable protocol, including the Simple Object Access Protocol (SOAP). FIGS. 7A and 7B each show examples of information that may be included in exemplary API calls.

FIG. 7A shows a flowchart of a process for retrieving metadata using an exemplary set of API calls TransactionOpen, TransactionInquiry, and TransactionClose. TransactionOpen is used to open a communication path between the search engine and the source of metadata. TransactionOpen takes one parameter, identified as PrivateKey. PrivateKey is an indicator for a relationship between the search engine and the source of metadata. If the relationship requires that the search engine pay the source of metadata for each query, then the PrivateKey may enable billing processes to take place. If there is no relationship between the search engine or the source of metadata, then PrivateKey may be null. The response to TransactionOpen is an identifier for the transaction, known as a TransactionID. The TransactionID may be used in subsequent communications to identify the transaction.

Accordingly, in block 702 of the process 700, a TransactionOpen communication is sent from the search engine to the source of metadata. The TransactionOpen command includes a PrivateKey. In block 704, in response to the TransactionOpen communication, a TransactionID is received from the source of metadata.

Following a TransactionOpen communication, one or more inquiries may be sent to the source of data using a TransactionInquiry communication. TransactionInquiry takes as a parameter SearchKeywordsList, which may be a set of one or more keywords. In some implementations, the SearchKeywordsList may be some or all of the text keywords that are provided as input from a user, or some or all of any other type of input provided by a user. TransactionInquiry may also take as parameters the TransactionID as well as the PrivateKey for the relationship between the search engine and the source of metadata. TransactionInquiry returns a ReferenceList, which includes pieces of metadata that are available to the source of metadata and related to the keywords (or other pieces of information) included in the SearchKeywordsList.

Accordingly, in block 706, a TransactionInquiry communication is sent from the search engine to the source of metadata that includes one or more text keywords that were included as part of the input provided to the search engine by a user. In block 708, one or more pieces of metadata information are received from the source of metadata.

Once all TransactionInquiry operations are completed, then a TransactionClose command may be sent to the source of metadata by the search engine. The TransactionClose command may take as a parameter the TransactionID for the communication session, such that the transaction may be closed. This may be used by the source of metadata to start a billing operation based on queries that were sent during the transaction or to start any other suitable operation(s) based on an end of the transaction.

Accordingly, in block 710, a TransactionClose communication is sent to the source of metadata, and the process 700 ends.

FIG. 7B shows an alternative process that may be followed by a search engine communicating with a source of metadata using an API. In the API used in the example of FIG. 7B, no relationship is established between the search engine and the source of metadata. Accordingly, commands like TransactionOpen and TransactionClose are unnecessary. Instead, only a TransactionInquiry command is sent.

In block 722 of process 720, a TransactionInquiry command is sent from the search engine to the source of metadata. The TransactionInquiry command includes a parameter SearchKeywordsList, which includes all or a portion of the input provided by a user to the search engine. In block 724, the search engine receives a response to the TransactionInquiry command that includes one or more pieces of metadata in a ReferenceList. Once the metadata is received in block 724, the process 720 ends.

Techniques discussed above with respect to retrieving metadata describe how the search engine retrieves metadata from the source of metadata. Techniques for use by the source of metadata for retrieving or storing metadata have not been discussed in detail. Though, it should be appreciated that how the metadata is created at the source of metadata, or techniques for use by the source of metadata in retrieving metadata, are not essential. Embodiments are not limited to operating with any source of metadata that uses a particular technique for retrieving metadata. Rather, any technique may be used by the source of metadata. Some embodiments may operate with a source of metadata that retrieves metadata according to the techniques for use by a policy server in locating and retrieving metadata and identity information that are described in U.S. patent application Ser. No. 12/423,023 (“the '023 Application”), filed date Apr. 14, 2009, titled “Discovery of inaccessible computer resources.” The '023 Application is incorporated herein in its entirety, at least for its discussion of policy servers and techniques for retrieving and aggregating metadata and identity information.

As discussed above, metadata may be any suitable information that describes an artifact and/or attributes of an artifact. Metadata may be created at any suitable time during any suitable processing of an artifact, including creating, testing, reviewing, storing, or transmitting an artifact. When an artifact is processed, metadata may be generated and stored by the entity (e.g., human or software agent) processing the artifact. Each entity that is processing an artifact may act as a source of metadata. Additionally or alternatively, a source of metadata may act to discover other sources of metadata, recover the metadata stored at each, and aggregate and store the metadata.

As one example of a way in which metadata may be created and stored, a software vendor may use configuration management software while developing software. The configuration management software may maintain development records that identify developers (e.g., human programmers) that interact with a software application being developed, a development environment for the software application, and changes made to the software application during development, among other attributes. The software vendor may also store documentation regarding the software development and an identification of an author of the documentation. Testing records and results may also be maintained along with an identification of a tester that carried out the testing. Multiple other pieces of information may be generated by a software vendor while developing a software application.

A source of metadata for the software vendor may act to retrieve and aggregate each piece of metadata from each of the records maintained by the software vendor. The source of metadata may be a server accessible to the search engine that includes a data store of metadata generated by the software vendor. The source of metadata may identify each of the records available on the network, retrieve those records, and store the information in association with information about the software application (i.e., an artifact) to which the metadata relates. A search engine may then query the source of metadata to retrieve metadata about the software application.

In embodiments, a source of metadata may act to transmit metadata in the same format the source of metadata has created or stored the metadata. In other embodiments, the source of metadata may perform any suitable transformation process on the metadata to reformat the metadata for use by a search engine. In some cases, transforming the metadata may also be done by the source of metadata to protect proprietary information available to the source of metadata. For example, by extracting metadata from records available to the source of metadata and storing the metadata in another format, or by reformatting the records, some information that the source of information does not want made publicly available to a search engine or to users may be kept hidden, while the metadata that may be useful to the search engine can be made public.

Once the search engine has retrieved the metadata, the search engine may perform the search using the metadata. As discussed above, the metadata may be used in any part of the search. Performing a search may include configuring a search engine to perform a search, searching a set of content, processing results of the searching, presenting results to a consumer of search results, or any other acts related to searching.

In some embodiments, metadata may be used in performing a search by returning the metadata as results of a search, without performing any additional search by a search engine of a set of content. When metadata is received by a search engine in response to a query of a source of metadata, the metadata may be formatted as a result of a search and presented to a user as the results of the search. In other embodiments, at least some of the metadata may be included in results presented to a consumer, but may not be used in other aspects of performing a search until a consumer requests that the metadata be used in other aspects of performing the search. In such embodiments, results of a search may be presented to a consumer with an identification of artifacts or sources of metadata, along with an option to use metadata to configure a search engine, search, and/or process results of searching, or use the metadata in any other way. Though, in other embodiments, metadata may be used in any other suitable manner to perform a search.

The manner in which a search engine may use metadata in performing a search may vary based on the type of search engine, the type(s) of content units searched by the search engine, the type(s) of metadata, and other factors. Accordingly, while exemplary techniques are discussed below, it should be appreciated that embodiments are not limited to using metadata in the manner described in the exemplary techniques.

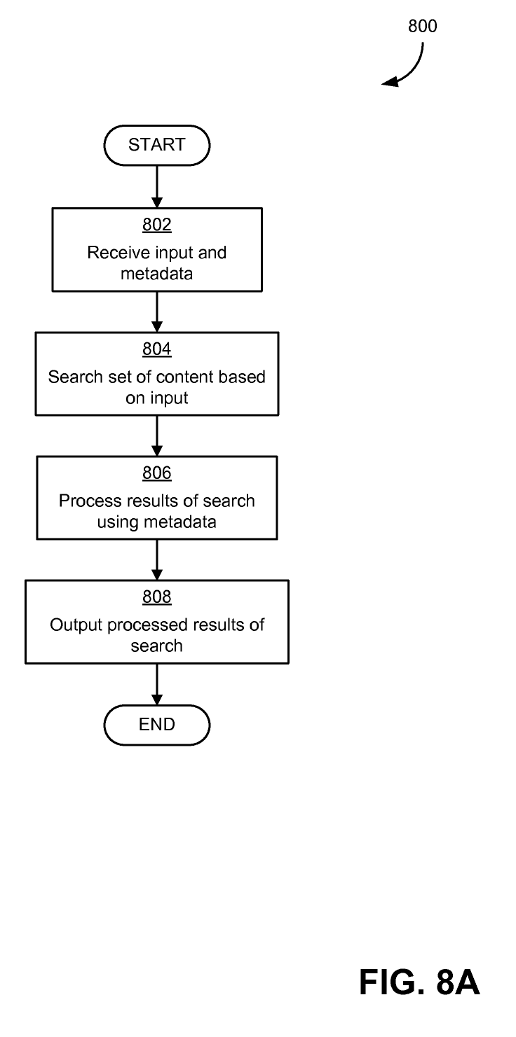

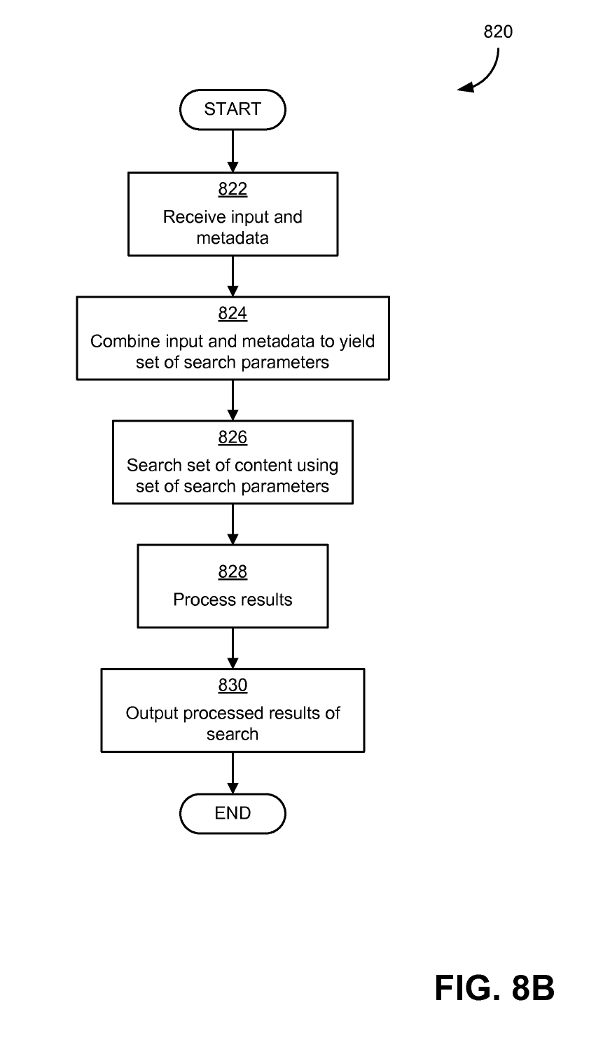

Process 800 of FIG. 8A begins in block 802, in which input from a user describing a search and metadata related to an artifact are made available to a search engine. The input and the metadata may be received in any suitable manner, including according to any of the techniques described above.

In block 804, the search engine searches a set of content based on the input provided by the user. This search may be carried out in any manner, including according to conventional searching techniques. For example, if the set of content includes documents and the input includes text keywords, the search engine may locate documents that include the text keywords of the input.

In block 804, if the search was successful, at least one content unit is determined to be a result of the search. In block 806, results of the search may then be processed in some way before presentation to a user. The processing may be done to promote or identify content units that may be relevant or reliable, or may be more relevant or more reliable than others. To do so, some search engines may employ processing techniques such as ranking or filtering that rank possibly relevant or reliable content units or that filter out possibly irrelevant or unreliable content units. Many different techniques exist for processing content units, and many different techniques exist for ranking and/or filtering content units.

In some embodiments, metadata is used in processing content units. In one example, a ranking is performed using the metadata. For example, once content units have been determined to be results of the search, the content units may be searched according to the metadata to determine those content units of the results that most closely match the metadata. If the metadata includes text keywords, then searching the content units according to the metadata may include determining whether any content units include those text keywords. If the metadata includes a date or date range, then searching the content units according to the metadata may include determining whether any content units were created on the date or during that date range. If the metadata includes an identity (e.g., of a developer of a software program), then searching the content units according to the metadata may include determining whether any content units were created by the person indicated by the identity or whether any content units quote the person indicated by the identity.

Once the content units have been searched according to the metadata, then the content units that included information identified by the metadata may be considered to be more relevant or more reliable than content units that did not include information identified by the metadata. This may be because the user has been determined to be seeking information about the artifact, and the metadata is known to be information about that artifact. If a content unit includes the metadata, then, that it may be considered to be more closely related to the artifact than a content unit that does not include the metadata, and therefore may be determined to be a more relevant or more reliable result of the search for the user.

A processing of the content units determined in block 804 is therefore performed in block 806, using the results of the search according to the metadata. In the example of FIG. 8A, the processing of block 806 may be a ranking. Accordingly, in block 806, content units that included information related to the metadata are ranked higher than content units that did not include information related to the metadata. Additionally, content units that included information more closely related to the metadata may be ranked higher than content units that included information less closely related to the metadata. In some cases, different types of metadata may be weighted differently when determining a ranking, such that when a content unit matches one higher-weighted piece of metadata, the content unit may be ranked higher than when a content unit matches a lower-weighted piece of metadata. Any suitable ranking technique may be employed by embodiments, as the embodiments are not limited to using any particular ranking technique.

Once the ranking of block 806 is completed, then the ranked content units are output as the results of the search in block 808 and the process 800 ends.

As discussed above, it should be appreciated that FIG. 8A illustrates a process of using metadata to process search results. Though, metadata may be used at any other point in performing a search. FIG. 8B shows another process where metadata is used in a different part of a process for performing a search, to illustrate that metadata may be used in different ways and in different parts. In the example of FIG. 8B, metadata is used in searching a set of content units.

The process 820 of FIG. 8B begins in block 822, in which input from a user and metadata are made available to a search engine. As in block 802 of FIG. 8A, this may be done in any suitable manner.

In block 824, information from the metadata is added to the input from the user. For example, if the input from the user includes text keywords, and the metadata includes text keywords, then the keywords may be combined to yield a single set of keywords. Other types of input and other types of metadata may be similarly combined, such that a set of search parameters is determined that includes both the input from the user and the metadata.

In block 826, the set of search parameters determined in block 824 is used to search a set of content. In this way, the metadata retrieved from the source of metadata is used in a search of the set of content and used to determine a set of results of the search. This may be done because the input has been determined to relate to some artifact, and the metadata is known to be related to that artifact, so the metadata may be used to perform a focused search of the set of content. In this way, only content units that are related to both the input and the metadata are returned as results of the searching, and thus only content units that are possibly related to the artifact (because the content units include the metadata relating to the artifact) are determined to be results. Thus, content units that are not related to the artifact and would not be relevant may be removed from the results of the searching.

The searching of block 826 may be carried out in any suitable manner, including according to known searching techniques, and may vary depending on the type of input, the type of metadata, and the type of content units to be searched.

In block 826, if the searching was successful, then at least one content unit is determined to be a result of the searching. The content unit(s) may then be processed in some way in block 828. For example, the content unit(s) may be ranked accordingly to how closely the content unit matches the set of search parameters, including how closely the content unit matches the input from the user and the metadata. Once the results are processed in block 828, the results may be output and the process 820 ends.

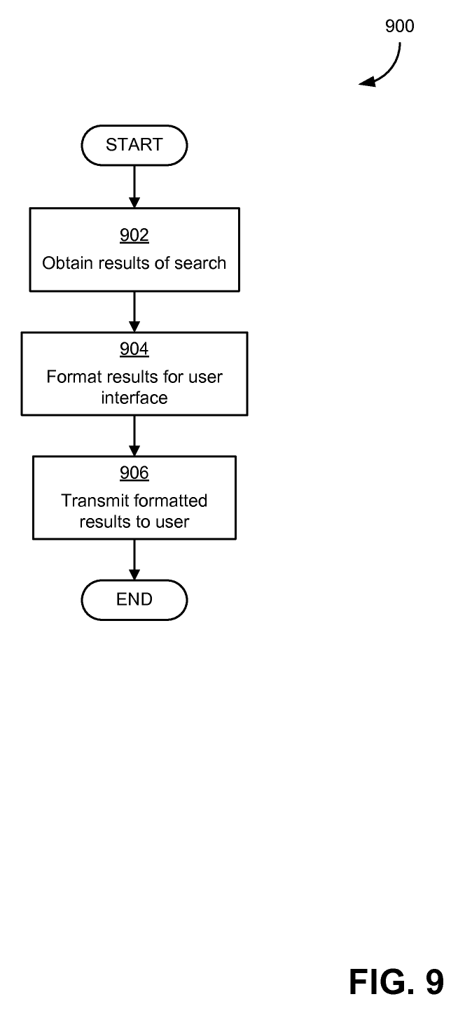

Once metadata has been used, in any suitable manner and in any suitable way, to perform a search and a listing of results has been determined, then results are returned to a user. In FIG. 3 above, input describing a search is received from a user at a client device and is transmitted to a server hosting a search engine. In the example of FIG. 9, results of a search are transmitted from a server to a client device. Though, as should be appreciated from the above discussion of FIG. 3, embodiments may operate in any suitable system of devices and in any suitable way, and embodiments are not limited to implementing the technique illustrated in FIG. 9 or to operating with a server and/or client device.

Process 900 of FIG. 9 begins in block 902, in which results of a search are obtained by a search engine. In block 904, the results are formatted so as to be presented to the user via a user interface. When the user interface is a web page to be displayed in a web browser, the formatting of block 904 may include creating a web page including a listing of at least some of the results of the search and links and/or buttons for interacting with the results or requesting more results. In some embodiments, formatting the results may also include identifying, in the results, the artifact(s) to which the input describing the search was determined to relate. The artifact(s) may be identified by name, or in any other suitable manner. In some cases, the source(s) of metadata that were contacted during a search may additionally or alternatively be identified, and/or information provided to the source(s) of metadata may be provided. Providing in the results an indication of the artifact(s) and source(s) of metadata may provide better information to a consumer of search results (e.g., a user) about what search was performed. The results may also include a way to retrieve more information about an artifact or from a source of metadata, such as by contacting a source of metadata with additional information. Additionally, in the embodiments described above that do not use the metadata in performing a search until a consumer requests the metadata to be used, formatting the results may also include presenting to the consumer an option to use the metadata to perform the search.

In block 906, the formatted results are transmitted to a client device via a communication network and, in block 908, the results are displayed to a user via a user interface, and the process 900 ends.

Described above are various examples of ways in which embodiments may operate to perform a search relating to an artifact using metadata about that artifact. Each of the techniques described above may be used in any suitable combination, including in combination with other techniques not explicitly described herein.

Further, it should be appreciated that each of the techniques described above are merely examples of ways in which embodiments may operate, and that others are possible. For example, while embodiments described above determine at the search engine (or at a software component of the search engine, or a software component related to and communicating with the search engine) an artifact to which input describing a search relates, in other embodiments a client device or user interface for a search engine may determine to which artifact(s) the input relates. As another example, while the metadata is described above as being used by the search engine on the server in performing the search, in some implementations the metadata may be used on the client device in performing the search, such as by using the metadata to perform a ranking of results of the search that were determined by the search engine.

Further, while embodiments discussed above described a search engine as determining an artifact to which an input relates, in some embodiments the search engine may additionally or alternatively determine a source of metadata that is associated with the input. At least some of the input may then be provided to the source of metadata, and the source of metadata may determine metadata corresponding to the input, such as by first determining an artifact to which the input relates. The source of metadata may then respond to the search engine with metadata.

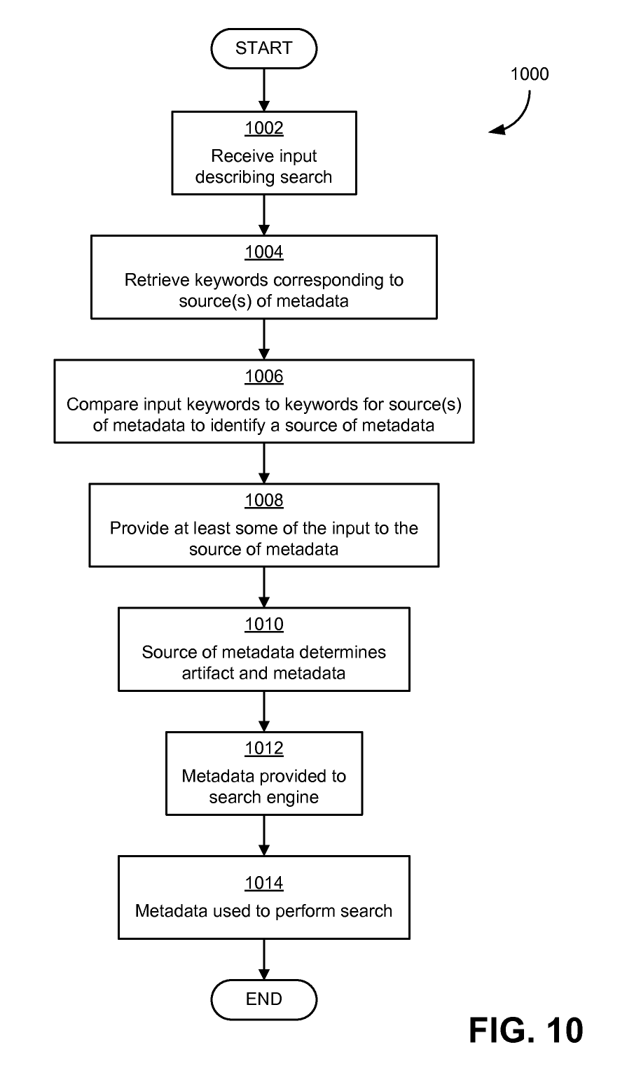

FIG. 10 illustrates one example of such a process. In block 1002 of process 1000, a search engine receives input describing a search desired to be performed by the search engine. The input, in this example, includes text keywords. The text keywords describe a search to be performed, in that the text keywords specify that documents that are to be located by the search engine should include one, some, or all of the text keywords.

In block 1004, a set of text keywords relating to each source of metadata of which the search engine is aware is retrieved. The text keywords associated with each source of metadata may be any suitable words that may describe artifacts with which the source of metadata is associated, or a class or category of artifacts with which the source of metadata is available, including artifact names or one or more words that may be associated with artifacts. For example, when a source of metadata is a software vendor, a keyword associated with the source of metadata may be a name of the vendor (e.g., “Microsoft”) or a name of a suite of products. A name of the vendor or the name of the suite of products may appear in input describing a search to be performed regarding a software application released by the vendor, and as such may be used to match the input to the source of metadata.

In block 1006, each of the text keywords of the input is compared to the text keywords associated with each of the sources of metadata to determine whether there is a match between any of the keywords. Each match is tracked, and a count for a number of matching keywords for each artifact is maintained. Once the input keywords have been compared to each of the text keywords for the sources of metadata, then the source of metadata with the most number of matching keywords is determined to be the source of metadata to which the input relates.

In block 1008, at least a portion of the input may be provided to the source of metadata by the search engine in any suitable communication that is requesting metadata. For example, any of the exemplary API communications discussed above may be used.

In block 1010, the source of metadata determines an artifact to which the input relates and at least one piece of metadata about the artifact. This may be done in any suitable manner. For example, techniques described above in connection with determining an artifact to which input relates may be implemented by the source of metadata. As another example, an enterprise search using the input may be performed to determine an artifact and/or at least one piece of metadata that are related to the input. As another example, techniques described in the '023 Application cited above, that may be implemented by policy servers to determine network data, may be used to determine an artifact and/or metadata. Any suitable technique may be used.

In block 1012, the metadata is provided by the source of metadata to the search engine and, in block 1014, the search engine uses the metadata in any suitable manner to perform a search. Once the search has been performed, the process 1000 ends.

In each of the exemplary embodiments described above, a source of metadata is described as a different computer, remotely accessible to the search engine, such as another server connected to a server hosting the search engine via a communication network. However, in some embodiments, the source of metadata may be stored local to the search engine or stored as a portion of a data store managed by the search engine. In some such cases, the source of metadata local to the search engine may aggregate metadata from one or more other sources of metadata.

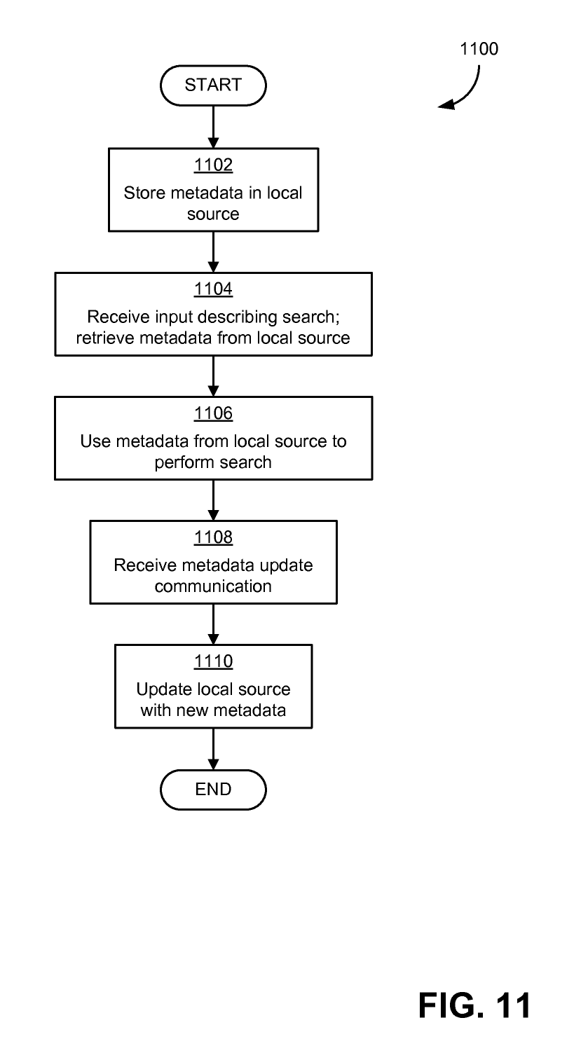

In one exemplary embodiment, a local source of metadata may be maintained by a search engine by periodically updating the local source of metadata based on communications received from one or more other sources of metadata. The search engine may then FIG. 11 shows one example of such a process.

Process 1100 of FIG. 11 begins in block 1102, in which a search engine receives metadata from a remote source of metadata and stores the metadata in a local source of metadata. The local source of metadata may be stored and managed in any suitable manner, as the manner of storage of the local source is not essential. In some cases, the local source of metadata may store individual pieces of metadata in a format that permits the local source to be searched according to artifacts to which each piece of metadata relates. In some such cases, each piece of metadata may be stored in association with information regarding an artifact, such as an artifact name or other identifier for an artifact.

In block 1104, the search engine receives input regarding a search to be performed and determines, using the local source of metadata, at least one piece of metadata that can be used by the search engine in performing the search. Determining at least one piece of metadata may be done in any suitable manner. If the local source of metadata stores each piece of metadata in association with an artifact, then determining at least one piece of metadata may include identifying at least one artifact to which the input relates and then retrieving metadata associated with that artifact.

In block 1106, the metadata is used by the search engine in performing the search. The metadata may be used to perform the search in any suitable manner, including according to techniques described above.

In block 1108, a metadata update communication is received at the search engine from a remote source of metadata. The metadata update communication may be received in response to a request for metadata from the search engine, which may have been sent by the search engine in response to any suitable trigger. Exemplary triggers for the search engine include a lapse of a predetermined amount of time or receiving a search relating to a particular piece of metadata. Alternatively, the metadata update communication may be received without a request from the search engine, but rather may be transmitted by the remote source of metadata in response to any suitable trigger. Exemplary triggers for the search engine include a lapse of a predetermined amount of time or detecting an update of a piece of metadata previously provided to the search engine. The metadata update communication may be received at the search engine at any suitable time and for any suitable reason(s).

In block 1110, the local source of metadata is updated with metadata included in the metadata update communication. Updating the local source of metadata may include replacing previously-stored metadata and/or adding new metadata. The local source may be updated using any suitable storage technique, as the manner of storing data is not essential. The manner of updating metadata in the local source may vary depending on a manner in which the local source is stored and managed.

Once the local source of metadata is updated, the process 1100 ends.

In some embodiments, a search engine may maintain a local source of metadata in addition to querying a remote source of metadata. In some such cases, the search engine may primarily rely on the remote source of metadata for metadata to be used to perform a search, but the search engine may supplement the metadata with metadata stored locally.

In one such case, a search engine may implement a query functionality to retrieve metadata from a location other than the source of metadata. For example, if a search engine determines that there is insufficient metadata about an artifact or that metadata available about an artifact is not useful to users, then the search engine may contact a human to retrieve additional metadata. The human that is contacted may be an administrator of the search engine, an administrator of a source of metadata, a person identified by metadata about an artifact (e.g., a developer of a software application), or any other person. The human may then supply metadata about an artifact or supply any other metadata, and the search engine may store this new metadata locally. When performing a search, the search engine may use metadata retrieved from a remote source of metadata and metadata retrieved from a local source of metadata.

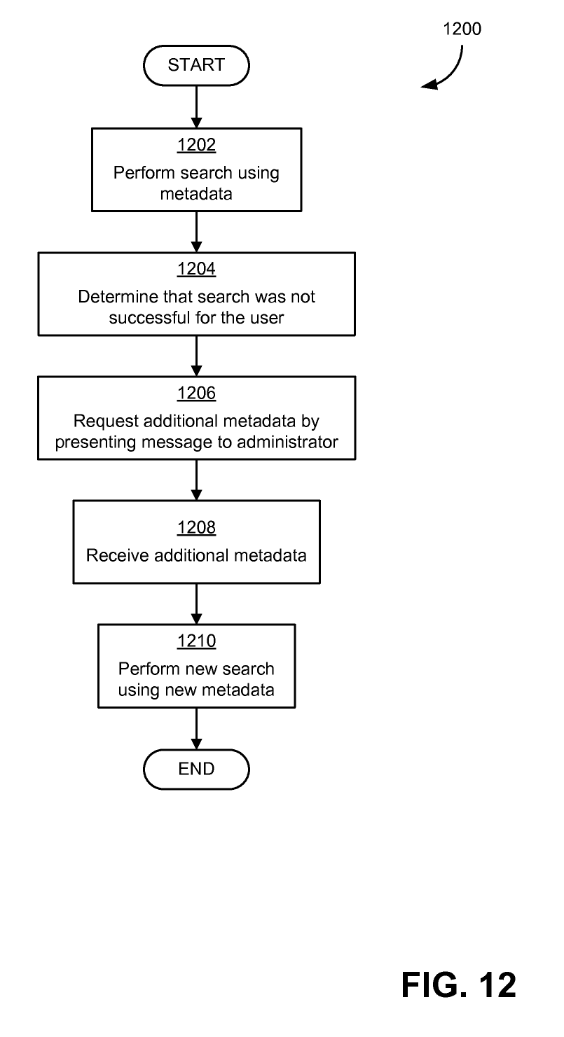

FIG. 12 shows one example of such a process. Process 1200 begins in block 1202, in which a search engine performs one or more searches using metadata and presents results of the searches to a user. In block 1204, the search engine detects that results of searches relating to an artifact are not useful to a user or are not what the user was looking for. Any technique may be used to determine whether results are not useful, including any conventional technique used to determine whether a search engine is performing well and/or producing useful results.

Because metadata is used by a search engine operating according to techniques described herein, the search engine may in block 1206 attempt to retrieve additional metadata about the artifact. The search engine 1206 may therefore present a message to an administrator of the search engine that identifies the artifact and identifies that search results regarding the artifact are not useful or are insufficiently useful. The message may also request metadata regarding the artifact. The request may identify a particular type of metadata that the search engine has determined it lacks, may identify a particular type of metadata that has previously been determined (either automatically, by the search engine, or based on a configuration of the search engine) to be useful, may identify any other particular type of metadata, or may only identify that metadata is needed.

In block 1208, the search engine receives additional metadata in response to the message. The additional metadata may have been determined by the administrator in any suitable manner, including by performing a query regarding that artifact, examining other references regarding the artifact, contacting a source of metadata regarding the artifact, or performing any other search for metadata.

In block 1210, the search engine receives a new search relating to the artifact and uses metadata retrieved from a remote source of metadata and the new metadata received in block 1208 to perform the search, and the process 1200 ends.

Techniques operating according to the principles described herein may be implemented in any suitable manner. Included in the discussion above are a series of flow charts showing the steps and acts of various processes that operate a search engine to perform a search using metadata. The processing and decision blocks of the flow charts above represent steps and acts that may be included in algorithms that carry out these various processes. Algorithms derived from these processes may be implemented as software integrated with and directing the operation of one or more multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit, or of any particular programming language or type of programming language. Rather, the flow charts illustrate the functional information one of ordinary skill in the art may use to fabricate circuits or to implement computer software algorithms to perform the processing of a particular apparatus carrying out the types of techniques described herein. It should also be appreciated that, unless otherwise indicated herein, the particular sequence of steps and acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, or any other suitable type of software. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations needed to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package, for example as a software program application such as an enterprise search engine, such as Sharepoint® Enterprise Search, or a web search engine, such as the Bing search engine, both available from the Microsoft Corporation of Redmond, Wash. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that the invention is not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

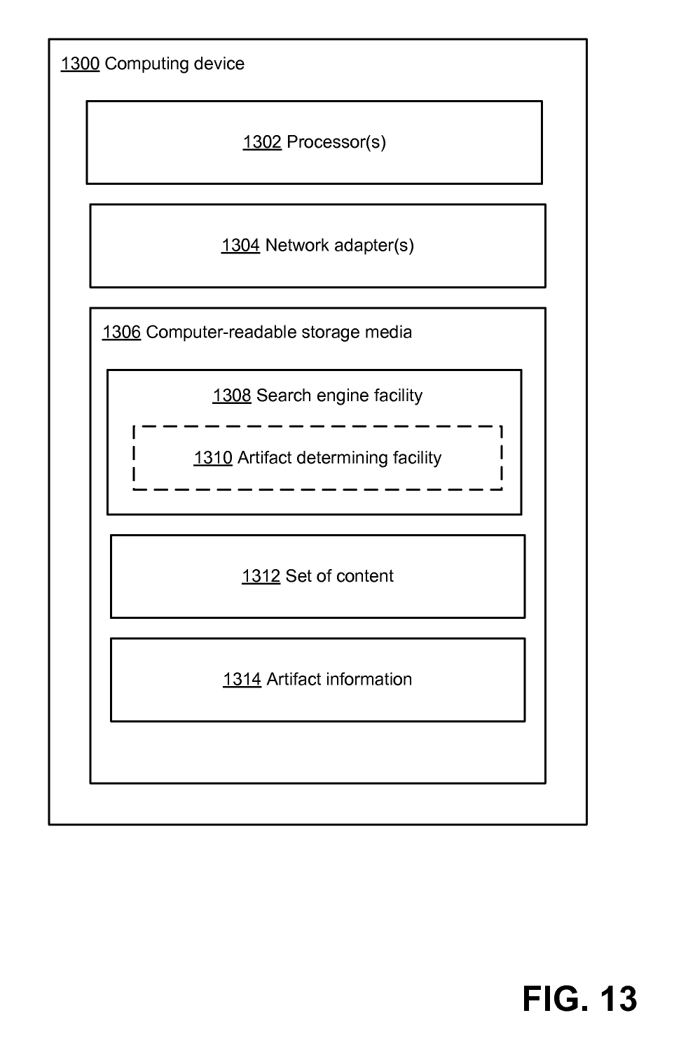

Computer-executable instructions implementing the techniques described herein (when implemented as one or more functional facilities or in any other manner) may, in some embodiments, be encoded on one or more computer-readable storage media to provide functionality to the storage media. These media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable storage medium may be implemented as computer-readable storage media 1306 of FIG. 13 described below (i.e., as a portion of a computing device 1300) or as a stand-alone, separate storage medium. It should be appreciated that, as used herein, “computer-readable media,” including “computer-readable storage media,” refers to non-transitory, tangible storage media having at least one physical property that may be altered in some way during a process of creating the medium with embedded data, a process of recording data thereon, or any other process of encoding the medium/media with data. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer device of FIG. 13 and the exemplary computer system of FIG. 2. Functional facilities that include these computer-executable instructions may be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

FIG. 13 illustrates one exemplary implementation of a computing device in the form of a computing device 1300 that may be used as a device hosting a search engine in a system implementing the techniques described herein, although others are possible. It should be appreciated that FIG. 13 is intended neither to be a depiction of necessary components for a computing device to operate in accordance with the principles described herein, nor a comprehensive depiction.

Computing device 1300 of FIG. 13 may include at least one processor 1302, a network adapter 1304, and computer-readable storage media 1306. Computing device 1300 may be, for example, a desktop or laptop personal computer, a server, or any other suitable computing device. Network adapter 1304 may be any suitable hardware and/or software to enable the computing device 1300 to communicate wirelessly with any other suitable computing device over any suitable computing network. The computing network may include a wireless access point as well as any suitable wired and/or wireless communication medium or media for exchanging data between two or more computers, including the Internet. Computer-readable media 1306 may be adapted to store data to be processed and/or instructions to be executed by processor 1302. Processor 1302 enables processing of data and execution of instructions. The data and instructions may be stored on the computer-readable storage media 1306 and may, for example, enable communication between components of the computing device 1300.

The data and instructions stored on computer-readable storage media 1306 may include computer-executable instructions implementing techniques which operate according to the principles described herein. In the example of FIG. 13, computer-readable storage media 1306 stores computer-executable instructions implementing various facilities and storing various information as described above. Computer-readable storage media 1306 may store a search engine facility 1308 to perform a search in any suitable manner. The search engine facility 1308 may also include an artifact determining facility 1310 to determine whether input provided to the search engine facility 1308 is related to one or more artifacts. In other embodiments, the artifact determining facility may be implemented separate from the search engine facility 1308, rather than as a component of the search engine facility 1308.

The computer-readable storage media 1306 may further store information that may be used by the search engine facility 1308 and the artifact determining facility 1310. For example, a set of content 1312 may be stored, which may include information about one or more content units that may be searched by the computer-readable storage media 1306. A set of artifact information 1314 may also be stored, which may include information about one or more artifacts, including, for example, names of artifacts, sources of metadata related to artifacts, and any information that may be used to match input to a search engine with one or more artifacts to which the input relates.

While not illustrated in FIG. 13, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments of the invention have been described where the techniques are implemented in circuitry and/or computer-executable instructions. It should be appreciated that the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A method of operating a search engine to perform a search for one or more content units, the method comprising:
operating at least one programmed processor to carry out at least one act, the at least one act being identified by executable instructions with which the at least one programmed processor is programmed, the at least one act comprising:
(A) receiving input regarding a search to be performed by the search engine;
(B) querying a source of metadata associated with an artifact with which the input is associated; and
(C) performing the search using metadata received from the source.

2. The method of claim 1, further comprising:
(D) determining whether the input is associated with one artifact of at least one artifact; and
(E) if the input is associated with an artifact, determining a source of metadata about that artifact.

3. The method of claim 2, wherein the input comprises at least one text keyword, and each artifact is associated with one or more artifact keywords, and
wherein the act (D) of determining whether the input is associated with any artifacts comprises comparing the at least one text keyword of the input to a set of artifact keywords to determine an artifact to which the input relates.

4. The method of claim 2, wherein a relationship exists between an operator of the search engine and each of at least one source of metadata, each source of metadata being associated with at least one artifact, and
wherein the method further comprises:
(D) determining whether the input is associated with an artifact that is associated with one of the at least one source of metadata.

5. The method of claim 1, wherein querying the source of metadata information comprises:
(B1) transmitting to the source of metadata at least some of the input.

6. The method of claim 1, wherein the act (C) of performing the search using the metadata comprises:
(C1) performing the search based on the input to determine at least one result of the search; and
(C2) ranking the at least one result using the metadata.

7. The method of claim 1, wherein the act (C) of performing the search using the metadata comprises:
(C1) combining the input and the metadata to yield an augmented input; and
(C2) performing the search based on the augmented input to determine at least one result of the search.

8. The method of claim 1, wherein the metadata is identity information for at least one person associated with the artifact.

9. The method of claim 8, wherein the at least one person associated with the artifact is at least one person that contributed to creation of the artifact.

10. At least one computer-readable storage medium encoded with computer-executable instructions that, when executed by a computer, cause the computer to carry out a method of operating a search engine to perform a search for one or more content units, the method comprising:
(A) receiving input describing a search to be performed, the input comprising at least one text keyword;
(B) comparing the at least one text keyword of the input to a set of artifact keywords associated with at least one artifact to determine an artifact to which the input relates;
(C) querying a source of metadata regarding the artifact;
(D) receiving, from the source of metadata, identity information for at least one person associated with the artifact; and
(E) performing the search using the identity information received from the source.

11. The at least one computer-readable storage medium of claim 10, wherein the act (E) of performing the search using the metadata comprises:
(E1) performing the search based on the input to determine at least one result of the search; and
(E2) ranking the at least one result using the metadata.

12. The at least one computer-readable storage medium of claim 10, wherein the act (E) of performing the search using the metadata comprises:
(E1) combining the input and the metadata to yield an augmented input; and
(E2) performing the search based on the augmented input to determine at least one result of the search.

13. The at least one computer-readable storage medium of claim 10, wherein querying the source of metadata information comprises:
(B1) transmitting to the source of metadata at least some of the input.

14. The at least one computer-readable storage medium of claim 10, wherein a relationship exists between an operator of the search engine and each of at least one source of metadata, each source of metadata being associated with at least one artifact, and
wherein the method further comprises:
(D) determining whether the input is associated with an artifact that is associated with one of the at least one source of metadata.

15. The at least one computer-readable storage medium of claim 14, wherein querying the source of metadata comprises providing to the source of metadata an identifier for the relationship.

16. An apparatus comprising:
at least one processor adapted to operate a search engine to perform a search for one or more content units by:
receiving input regarding a search to be performed by the search engine;
querying a source of metadata information associated with an artifact with which the input is associated; and
performing the search using metadata information received from the source.

17. The apparatus of claim 16, wherein the at least one processor is further adapted to:
determine whether the input is associated with one artifact of at least one artifact; and
if the input is associated with an artifact, determine a source of metadata about that artifact.

18. The apparatus of claim 17, wherein the input comprises at least one text keyword, and each artifact is associated with one or more artifact keywords, and
wherein the at least one processor is adapted to determine whether the input is associated with any artifacts by comparing the at least one text keyword of the input to a set of artifact keywords to determine an artifact to which the input relates.

19. The apparatus of claim 16, wherein the at least one processor is adapted to perform the search using the metadata by:
performing the search based on the input to determine at least one result of the search; and
ranking the at least one result using the metadata.

20. The apparatus of claim 16, wherein the at least one processor is adapted to perform the search using the metadata by:
combining the input and the metadata to yield an augmented input; and
performing the search based on the augmented input to determine at least one result of the search.
